(19) United States
(12) Patent Application Publication
(10) Pub. No.: US 2026/0319083 A1
(43) Pub. Date: Oct. 15, 2026

(54) VEHICULAR RADAR SENSING SYSTEM FOR IN-CABIN MONITORING WITH SMALL OBJECT DETECTION

(71) Applicant: Magna Electronics Inc., Auburn Hills, MI (US)

(72) Inventor: Prateek V. Hegde, Karnataka (IN)

(21) Appl. No.: 19/640,588

(22) Filed: Apr. 7, 2026

Related U.S. Application Data
(60) Provisional application No. 63/787,008, filed on Apr. 11, 2025.

(51) Int. Cl. G01S 13/34; B60N 2/00; B60R 22/48; G01S 7/02; G01S 7/41

(52) U.S. Cl. CPC G01S 13/34; B60R 22/48; G01S 7/412; G01S 7/417

(57) ABSTRACT

A vehicular cabin monitoring system includes a radar sensor disposed within an interior cabin of a vehicle. The radar sensor senses within the interior cabin of the vehicle. The system, via processing at an electronic control unit (ECU) of sensor data captured by the radar sensor, monitors a passenger region within the interior cabin of the vehicle. Based at least in part on a number of occupants present at the passenger region, and responsive to sensor data representative of a first passenger region of the passenger region and sensor data representative of a second passenger region of the passenger region being different by at least 10 dBsm RCS, the system determines a first position of a first occupant present at the first passenger region and determines a second position of a second occupant present at the second passenger region.

### CROSS REFERENCE TO RELATED APPLICATION

The present application claims the filing benefits of U.S. provisional application Ser. No. 63/787,008, filed Apr. 11, 2025, which is hereby incorporated herein by reference in its entirety.

### FIELD OF THE INVENTION

The present invention relates generally to a vehicular cabin monitoring system for a vehicle and, more particularly, to a vehicular cabin monitoring system that utilizes one or more radar sensors at a vehicle.

### BACKGROUND OF THE INVENTION

Use of radar sensors in vehicle sensing systems is common and known. Examples of such known systems are described in U.S. Pat. Nos. 9,146,898; 8,027,029 and/or 8,013,780, which are hereby incorporated herein by reference in their entireties.

### SUMMARY OF THE INVENTION

An example vehicular cabin monitoring system includes a radar sensor disposed within an interior cabin of a vehicle equipped with the vehicular cabin monitoring system. The radar sensor senses within the interior cabin of the vehicle. Sensor data captured by the radar sensor is transferred to an electronic control unit (ECU). The ECU includes electronic circuitry and associated software, and the electronic circuitry of the ECU includes a processor operable to process sensor data transferred to the ECU. The vehicular cabin monitoring system, via processing at the ECU of sensor data captured by the radar sensor, monitors a passenger region within the interior cabin of the vehicle. The vehicular cabin monitoring system, based at least in part on a number of occupants present at the passenger region within the interior cabin of the vehicle, and responsive to sensor data representative of a first passenger region of the passenger region within the interior cabin of the vehicle and sensor data representative of a second passenger region of the passenger region within the interior cabin of the vehicle being different by at least 10 dBsm RCS, (i) determines a first position of a first occupant present at the first passenger region within the interior cabin of the vehicle and (ii) determines a second position of a second occupant present at the second passenger region within the interior cabin of the vehicle. The number of occupants present at the passenger region may be estimated or determined, such as via processing of sensor data captured by the radar sensor and/or via processing by a convolutional neural network (CNN), or received from another system of the vehicle, such as a seatbelt monitoring system.

These and other objects, advantages, purposes and features of the present invention will become apparent upon review of the following specification in conjunction with the drawings.

### BRIEF DESCRIPTION OF THE DRAWINGS

FIG. 1 is a side view of a vehicle having a vehicular cabin monitoring system;

FIG. 2 is a schematic diagram of the vehicular cabin monitoring system;

FIG. 3 is a schematic diagram of a weak target disposed within the interior cabin of the vehicle;

FIG. 4 is a schematic diagram of an adult and a weak target disposed within the interior cabin of the vehicle;

FIG. 5 is a schematic diagram of signal processing algorithms;

FIG. 6 is a table of mean square error (MSE) for different target SNRs;

FIG. 7 is a table of MSE with 20 degree target separation;

FIG. 8 is a table of MSE with 40 degree target separation

FIG. 9 is a table of MSE performance on different RCS;

FIG. 10 is a table of performance on different RCS values;

FIG. 11 shows LAB data for a single simulated target;

FIG. 12 shows LAB data for multiple simulated targets;

FIG. 13 shows LAB data for a first target at 20 degrees and 5 dBsm and a second target at −20 degrees and −5 dBsm;

FIG. 14 shows LAB data for a first target at 20 degrees and 0 dBsm and a second target at −20 degrees and −5 dBsm;

FIG. 15 shows LAB data for a first target at 20 degrees and 10 dBsm and a second target at −20 degrees and −5 dBsm;

FIG. 16 shows LAB data for a first target at 20 degrees and 10 dBsm and a second target at −20 degrees and −10 dBsm;

FIG. 17 shows LAB data for a first target at 20 degrees and 5 dBsm and a second target at −20 degrees and −5 dBsm;

FIG. 18 shows LAB data for a first target at 20 degrees and 0 dBsm and a second target at −20 degrees and −20 dBsm;

FIG. 19 shows LAB data for a first target at 10 degrees and 10 dBsm and a second target at −10 degrees and −10 dBsm;

FIG. 20 shows LAB data for a first target at 10 degrees and 5 dBsm and a second target at −10 degrees and −5 dBsm;

FIG. 21 shows LAB data for a first target at 10 degrees and 0 dBsm and a second target at −10 degrees and −15 dBsm; and

FIG. 22 shows LAB data for a first target at 10 degrees and 5 dBsm and a second target at −10 degrees and −15 dBsm.

### DESCRIPTION OF THE PREFERRED EMBODIMENTS

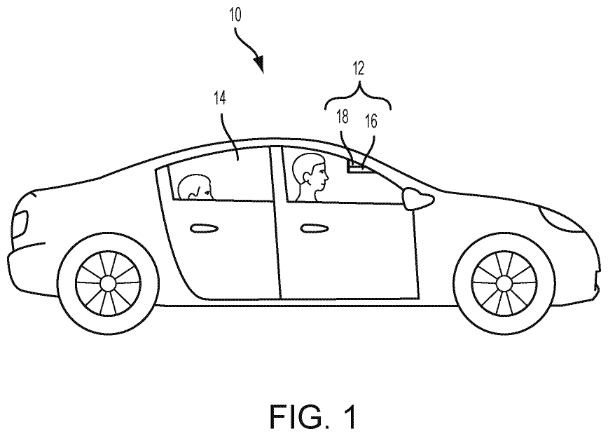

Referring now to the drawings and the illustrative embodiments depicted therein, a vehicular cabin monitoring system 12 for a vehicle 10 is configured to detect presence of occupants within the interior cabin 14 of the vehicle 10 (FIG. 1). For example, the system 12 may include one or more radar sensors 16 disposed at the interior cabin 14 of the vehicle 10 and that sense respective regions of the interior cabin 14 of the vehicle 10. The system 12 further includes a control or electronic control unit (ECU) 18 that includes electronic circuitry and associated software, such as a data processor or image processor for processing sensor data captured by the one or more sensors 16, whereby the ECU 18 may process sensor data captured by the one or more radar sensors 16 to detect presence of occupants 11, determine conditions of the occupants, and the like, as discussed further below. Although shown as disposed at an overhead console module of the vehicle 10, it should be understood that the one or more sensors 16 and/or the ECU 18 may be disposed at any suitable portion of the interior cabin 14 of the vehicle 10 for sensing regions of the interior cabin 14, such as at an interior rearview mirror assembly, a light module (e.g., a reading light or dome light), a grab handle module, and/or at or behind the vehicle headliner. The data transfer or signal communication from the one or more sensors 16 to the ECU 18 may comprise any suitable data or communication link, such as a vehicle network bus or the like of the equipped vehicle.

Leaving children or animals unattended in a hot car can be a dangerous situation. Some jurisdictions may require vehicles to have systems that can detect if a child is present alone inside the vehicle. These systems may also be required to locate the positions of occupants so that seat belt reminders may be given. Because of the complex environment inside the vehicle, a radar system sensing within the vehicle may struggle to differentiate sensing the occupants within the vehicle from spurious reflections from inanimate objects within the vehicle. The cabin monitoring system may reduce the effect of these reflections, such as to identify whether a child is left alone while also localizing the occupants when needed.

Often, the radar received signal is weak due to various blockages inside the vehicle where it is mounted. The radar or system may have difficulty in distinguishing the target from the received weak signal along with the background noise. Also, the system may need to decipher a weak signal when it is masked by a stronger signal. For example, when an adult and a smaller child are sitting next to each other, the stronger adult reflection signal may mask the weaker child reflection signal, making it hard to detect the child using traditional methods. The environment inside the vehicle may further complicate detection because of the high level of obstructions, increasing the chances of the radar picking up signals that are bounced around rather than coming directly from the target.

In such situations, the direct signal from the target may be very weak, leading to inaccurate detection and incorrect identification of the target's position. To improve accuracy, high-resolution signal processing techniques may be used to better determine the target's position.

To detect these targets accurately, the cabin monitoring system may use advanced high angle resolution methods. The high-resolution methods may typically require an input indicating the number of targets within the vehicle cabin in advance and the system may remove this drawback.

The system uses an artificial intelligence system to determine or find the number of targets. In ICS radar systems, potential targets are confined to a predefined set of positions, such as seats and footwells, thereby reducing the complexity from infinite possible target locations to a finite and manageable set of defined positions.

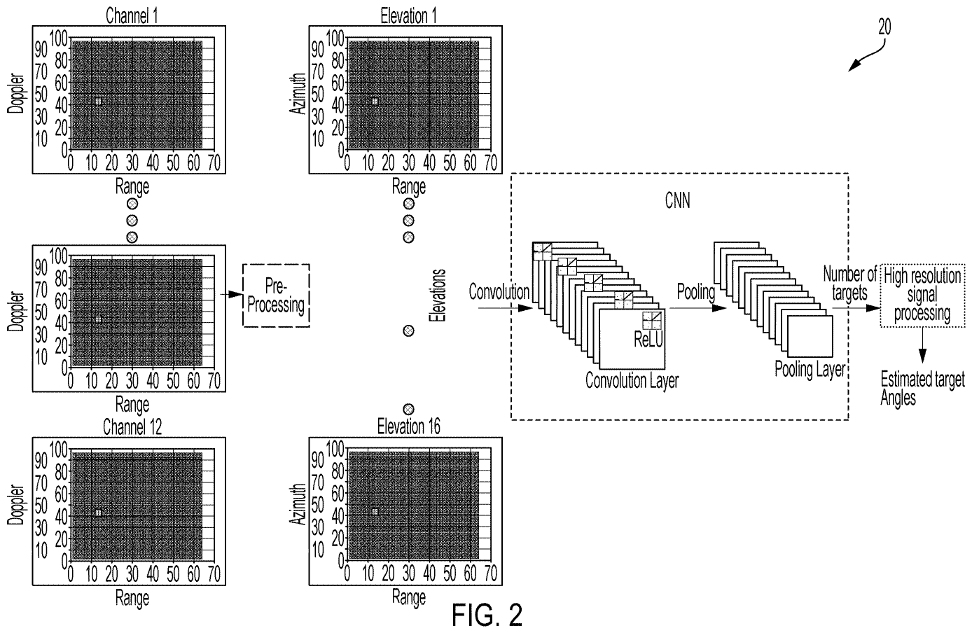

The system may use an artificial intelligence (AI) system (e.g., a Convolutional Neural Network (CNN)) to determine the number of targets by training the network with Range-Angle maps. Once trained, the stable environment allows the trained network model to be used to find the number of targets, which is then provided as input to the high-resolution algorithm to accurately determine target positions. This approach significantly improves the target position estimation. Also, the number of targets is to be estimated only when the environment changes, which may be identified by the received signal power. FIG. 2 may represent a block diagram of the proposed system 20.

Child presence detection systems are becoming a fundamental safety necessity. Radars are used to detect living occupants inside vehicles, and the signatures returned by these radars help determine if the detected object is an adult or a child. Traditional signal processing methods using Frequency Modulated Continuous Wave (FMCW) radar face significant challenges in accurately detecting targets due to the environment, which often has strong multipath effects and high blockage levels. In many situations, the target's signal intensity is very low due to the radar's mounting location, resulting in a poor signal-to-noise ratio (SNR). Lower SNR leads to erroneous target estimation.

When an adult and an infant are seated next to each other, there is typically a 10 dBsm RCS difference, making it difficult to detect the child using traditional signal processing techniques. The environment further complicates detection due to the high level of occlusion, increasing the likelihood of detecting the target via multipath rather than the direct path. In such cases, the direct path signal may have a very low SNR, leading to inaccurate target position estimation and incorrect localization and classification. High-resolution signal processing techniques could be valuable in accurately detecting the target's position in these scenarios.

Frequency Modulated Continuous Wave (FMCW) radar is a type of radar system that is widely used for various applications, including automotive radar, level measurement, and industrial sensing. FMCW radar systems are known for their ability to measure both the range and velocity of targets with high accuracy.

Unlike pulsed radar systems that transmit short bursts of energy, FMCW radar continuously transmits a signal. This signal is frequency-modulated, meaning its frequency changes over time in a controlled manner.

The transmitted signal is typically a linear frequency sweep, also known as a chirp. The frequency of the signal increases linearly over time, then resets and repeats. This modulation allows the radar to measure the distance to a target by analyzing the frequency difference between the transmitted and received signals.

The radar system 16 generates a continuous wave signal that is frequency-modulated. This signal is transmitted through an antenna towards the target 11. The transmitted signal reflects off the target 11 and returns to the radar system 16. The reflected signal is received by the radar's antenna. The received signal is mixed with a portion of the transmitted signal (known as the reference signal) to produce an intermediate frequency (IF) signal. This process is called heterodyne mixing. The frequency difference between the transmitted signal and the received signal is proportional to the time delay caused by the round-trip travel to the target 11 and back. This time delay is directly related to the distance to the target 11. By analyzing the frequency difference (beat frequency) between the transmitted and received signals, the radar system can calculate the range to the target. The beat frequency is given by,

$$Δ R = \frac{c}{2 B}$$

where ΔR is the range resolution, c is the speed of light, and B is the bandwidth of the frequency sweep. Throughout the below equations, f_{b} is the beat frequency, R is the range to the target, Δf is the frequency sweep range, and T is the sweep time.

Frequency Modulated Continuous Wave (FMCW) radar systems measure the distance to a target by analyzing the frequency difference between the transmitted and received signals. By analyzing the beat frequency, the radar system can calculate the range to the target 11 using an equation.

Range resolution refers to the radar system's ability to distinguish between two closely spaced targets. It is determined by the bandwidth of the frequency sweep.

Frequency Modulated Continuous Wave (FMCW) radar systems can measure the velocity of a target using the Doppler effect. When a target is moving relative to the radar, the frequency of the reflected signal is shifted due to this relative motion. This frequency shift, known as the Doppler shift, is proportional to the target's velocity.

The Doppler effect causes a change in frequency of the reflected signal when the target is moving. If the target is moving towards the radar, the frequency increases, if the target is moving away, the frequency decreases. The frequency shift f_{d} due to the Doppler effect is given by,

$${f}_{d} = 2 \frac{{vf}_{0}}{c}$$

where v is the velocity of the target, f₀ is the transmitted frequency, and c is the speed of light.

The beat frequency (f_{b}) observed in FMCW radar is a combination of the range beat frequency and the Doppler shift. It can be expressed as,

f_{b}=fᵣ−f_{d}

where f_{b} is the observed beat frequency, fᵣ is the range beat frequency, and f_{d} is the Doppler frequency shift.

The Doppler effect causes a change in frequency of the reflected signal when the target is moving. If the target is moving towards the radar, the frequency increases, if the target is moving away, the frequency decreases. The range beat frequency (fᵣ) is given by,

$${f}_{r} = \frac{2 R Δ f}{cT}$$

where R is the range to the target, Δf is the frequency sweep range, and T is the sweep time.

Once the Doppler shift (f_{d}) is isolated, the target's velocity (v) can be calculated using the Doppler equation,

$$v = \frac{{f}_{d} c}{2 {f}_{0} cos ( θ )}$$

where v is the velocity of the target, f_{d} is the doppler frequency, c is the speed of light and θ is direction of the target movement.

Multiple Input Multiple Output (MIMO) is a technology that uses multiple antennas at both the transmitter and receiver to improve communication performance. In the context of FMCW radar, MIMO technology enhances the radar's ability to detect and estimate the position and velocity of multiple targets simultaneously.

MIMO radar systems use multiple transmit and receive antennas. This configuration allows the radar 16 to transmit multiple signals simultaneously and receive multiple reflections from targets. The use of multiple antennas provides spatial diversity, which improves the radar's ability to distinguish between targets that are close together. Spatial diversity helps in reducing the effects of fading and interference. MIMO radar systems can use beamforming techniques to focus the transmitted energy in specific directions. Beamforming improves the radar's resolution and accuracy in detecting targets 11. Angle estimation is a critical aspect of radar systems, as it determines the direction of the target relative to the radar. MIMO radar systems enhance angle estimation by leveraging the spatial diversity provided by multiple antennas. MIMO radar systems typically use an array of antennas arranged in specific configurations, such as linear or planar arrays. The configuration of the antenna array affects the radar's ability to estimate angles. MIMO radar systems use advanced signal processing techniques to estimate the angle of arrival (AoA) of the reflected signals. These techniques include methods such as MUSIC (Multiple Signal Classification) and ESPRIT (Estimation of Signal Parameters via Rotational Invariance Techniques). The AoA is the angle at which the reflected signal arrives at the radar's receive antennas. By analyzing the phase differences between the received signals at different antennas, the radar can estimate the AoA. The phase difference (Δφ) between the signals received at two antennas is given by,

$$Δ ϕ = \frac{2 π d sin ( θ )}{λ}$$

where d is the distance between the antennas, θ is the angle arrival, and λ is the wavelength of the transmitted signal. The angle of arrival can be calculated using the phase difference,

$$θ = arcsin ( \frac{Δ ϕ λ}{2 π d} )$$

FMCW radar systems can achieve high range resolution due to the wide bandwidth of the frequency sweep. Continuous wave transmission allows for constant monitoring of the target 11 without the need for pulsed signals. FMCW radar can simultaneously measure the range and velocity of targets, making it suitable for applications like automotive radar. Continuous wave transmission typically requires less power compared to pulsed radar systems. FMCW radar is used in adaptive cruise control, collision avoidance, and parking assistance systems. FMCW radar is used to measure the level of liquids and solids in tanks and silos. FMCW radar is used for object detection and distance measurement in industrial automation. FMCW radar systems work by continuously transmitting a frequency-modulated signal and analyzing the frequency difference between the transmitted and received signals to measure the range and velocity of targets. Components of an FMCW radar system include the transmitter, receiver, mixer, and signal processing unit. FMCW radar offers high resolution, continuous operation, and the ability to measure both range and velocity, making it suitable for various applications in automotive, industrial, and level measurement fields.

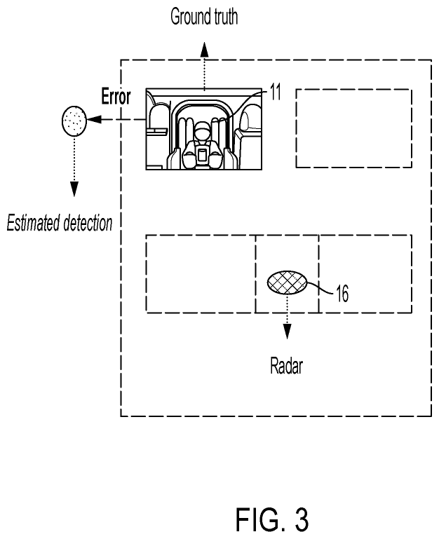

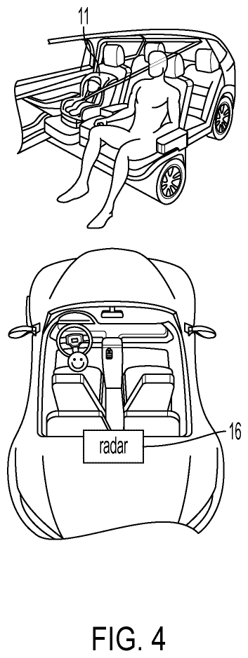

The radar 16 is positioned in a location where target visibility is limited, leading to inaccuracies in object localization and significant degradation in system performance due to angle errors (FIG. 3). Traditional signal processing techniques often fail to detect a weak target when a strong target is present. Similarly, in the presence of a strong adult, a weaker child is likely to be overwhelmed by noise, as illustrated in FIG. 4.

MIMO (Multiple-Input Multiple-Output) radar systems have gained significant attention due to their enhanced target detection and parameter estimation capabilities. These systems utilize multiple antennas for transmitting and receiving signals, which improves spatial resolution and detection performance. MIMO radar may be effective in automotive applications.

The Matrix Pencil method is a powerful technique for estimating the parameters of exponentially damped or undamped sinusoids in noise. This method is particularly useful in signal processing applications where accurate parameter estimation is crucial. The Matrix Pencil method may be applied to radar signal processing and communications.

ESPRIT (Estimation of Signal Parameters via Rotational Invariance Techniques) is a method for estimating the parameters of sinusoids in noise. This technique leverages the rotational invariance property of signal subspaces to provide accurate parameter estimation. ESPRIT may be applied in various signal processing domains, including radar, communications, and array processing.

The Capon beamforming algorithm may be used for enhancing signal reception in array processing. An improved version of this algorithm involves the calculation of the inverse covariance matrix, which provides better performance in terms of resolution and interference suppression. This method may significantly improve the accuracy and reliability of beamforming in various applications.

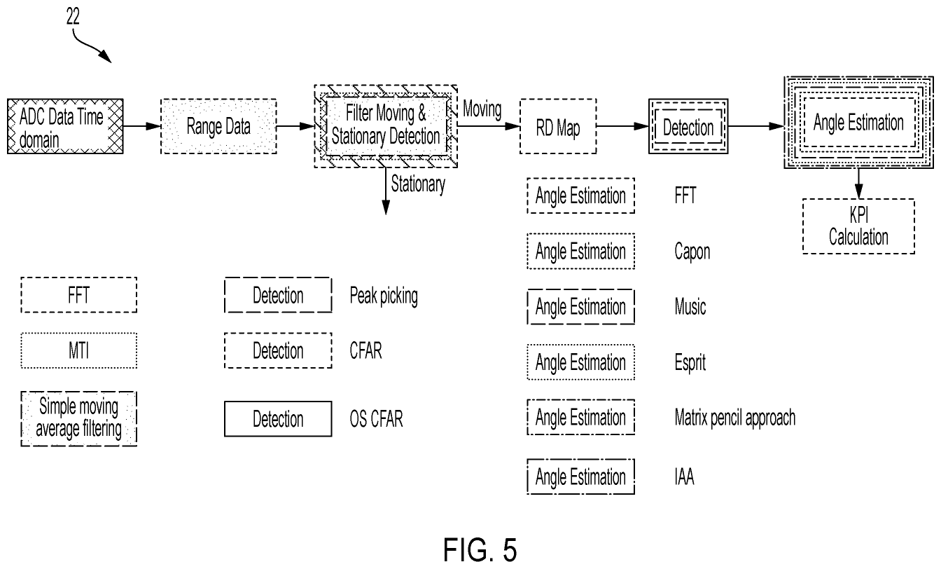

FIG. 5 shows an example signal processing algorithm 22. The Cramer-Rao Lower Bound (CRLB) provides the variance that can be achieved by the best unbiased estimator. It is a fundamental concept in parameter estimation theory, particularly relevant in signal processing applications.

x(t)=a(t)*s(φ)+n(t)

where α is the amplitude of the received signal, φ is the angle of arrival, n is the gaussian random noise (N(0,1)), and t is the time interval. The CRLB for the variance of the target direction estimate var(φ) is given by,

$$var ( ϕ ) \geq \frac{6 {σ}^{2} {sin}^{2} ( ϕ )}{{α}^{2} N ( {N}^{2} - 1 ) {k}^{2} {d}^{2}} = CRLB$$

where σ² is the noise variance, a is the signal amplitude, k=2π/λ is the wavenumber, A is the wavelength, N is the number of antenna elements, and d is the distance between receiver antenna elements.

As the Signal-to-Noise Ratio (SNR) increases, the CRLB reduces. The denominator of the CRLB is proportional to N(N²−1)k²d², which is proportional to the electrical length of the array, the length in terms of wavelength. The sine term in the numerator indicates that the beamwidth increases as the radar scans off broadside. Hence, the beam broadening factor makes the target direction estimate worse. It is clear from CRLB, that SNR plays a vital role in estimating the target position. So the system compares different algorithms with respect to its accuracy in low RCS scenarios.

The data model is given by,

x=Sα+n

S=[S(φ₁),S(φ₂), . . . S(φ_{M})]

α=[α¹,α², . . . α^{M}]^{T}

The matrix S is an N×M matrix of the M steering vectors. Assuming that the different signals are uncorrelated, the correlation matrix of x can be written as,

$$R = 𝔼 [ {xx}^{H} ] = 𝔼 [ S α {α}^{H} {S}^{H} ] + 𝔼 [ {nn}^{H} ] = {SAS}^{H} + {σ}^{2} I$$

$${R}^{S} + {σ}^{2} I$$

where

$${R}^{S} = {SAS}^{H}$$

$$A = [ \begin{matrix}𝔼 [ {\vert {α}_{1} \vert}^{2} ] & 0 & … & 0 \\ 0 & 𝔼 [ {\vert {α}_{2} \vert}^{2} ] & … & 0 \\ ⋮ & ⋮ & ⋱ & ⋮ \\ 0 & 0 & … & 𝔼 [ {\vert {α}_{M} \vert}^{2} ]\end{matrix} ]$$

The signal covariance matrix, Rₛ, is clearly an N×N matrix with rank M. It therefore has N−M eigenvectors corresponding to the zero eigenvalue. Let qₘ be such an eigenvector. Therefore,

$${R}^{S} {q}^{m} = {SAS}^{H} {q}^{m} = 0 ⇒ {q}^{{m}^{H}} {SAS}^{H} {q}^{m} = 0 ⇒ {S}^{H} {q}^{m} = 0$$

where this final equation is valid since the matrix A is clearly positive definite. The equation implies that all N−M eigenvectors (q^{m}) of R^{S} corresponding to the zero eigenvalue M signal steering vectors. This is the basis for MUSIC. Call Qₙ the N×(N−M) matrix of these eigenvectors. MUSIC plots the pseudo-spectrum,

$${P}_{MUSIC} ( ϕ ) = \frac{1}{{\sum }_{m = 1}^{N - M} {\vert {S}^{H} ( ϕ ) {q}_{m} \vert}^{2}} = \frac{1}{{S}^{H} ( ϕ ) {Q}_{n} {Q}_{n}^{H} s ( ϕ )} = \frac{1}{{‖ {Q}_{n}^{H} s ( ϕ ) ‖}^{2}}$$

Note that since the eigenvectors making up Qₙ are orthogonal to the signal steering vectors, the denominator becomes zero when φ is a signal direction. Therefore, the estimated signal directions are the M largest peaks in the pseudo-spectrum. However, in any practical situation, the signal covariance matrix Rₛ would not be available. The signal covariance matrix R may be estimated. The eigenvectors in Qₙ can be estimated from the eigenvectors of R. For any eigenvector qₘ∈Q,

Rₛqₘ=λqₘ⇒Rqₘ=Rₛqₘ+σ²Iqₘ=(λₘ+σ²)qₘ

That is, any eigenvector of Rₛ is also an eigenvector of R with corresponding eigenvalue λ+σ². Let Rₛ=QΛQ^{H}. Therefore

$$R = Q ( ∧ + {σ}^{2} I ) {Q}^{H} = Q [ \begin{matrix}{λ}_{1} + {σ}^{2} & 0 & … & 0 & \\ 0 & {λ}_{2} + {σ}^{2} & … & 0 & \\ ⋮ & ⋮ & ⋱ & ⋮ & \\ 0 & 0 & … & {λ}_{M} + {σ}^{2} & \\ 0 & 0 & … & 0 & {σ}^{2} \\ ⋮ & ⋮ & ⋱ & ⋮ & \\ 0 & 0 & … & 0 & {σ}^{2}\end{matrix} ] {Q}^{H}$$

Based on this eigendecomposition, we can partition the eigenvector matrix Q into a signal matrix Qₛ with M columns, corresponding to the M signal eigenvalues, and a matrix Qₙ, with (N−M) columns, corresponding to the noise eigenvalues (σ²). Note that Qₙ, the N×(N−M) matrix of eigenvectors corresponding to the noise eigenvalue (σ²), is exactly the same as the matrix of eigenvectors of Rₛ corresponding to the zero-eigenvalue. This is the matrix used in equations above. Qₛ defines the signal subspace, while Qₙ defines the noise subspace. Notably, the m-th signal eigenvalue is given by

λ^{m}+σ²=N|β^{m}|²+σ²

The smallest eigenvalues of R are the noise eigenvalues and are all equal to σ², i.e., one way of distinguishing between the signal and noise eigenvalues (equivalently the signal and noise subspaces) is to determine the number of small eigenvalues that are equal. By orthogonality of,

Q,Qₛ⊥Qₙ

all noise eigenvectors are orthogonal to the signal,

$${P}_{MUSIC} ( ϕ ) = \frac{1}{{\sum }_{m = M + 1}^{N} {\vert {q}_{m}^{H} s ( ϕ ) \vert}^{2}} = \frac{1}{{S}^{H} ( ϕ ) {Q}_{n} {Q}_{n}^{H} s ( ϕ )}$$

where qₘ is one of the (N−M) noise eigenvectors. If φ is equal to the direction of arrival (DOA) of one of the signals, s(φ)⊥qₘ and the denominator is identically zero. MUSIC, therefore, identifies as the directions of arrival, the peaks of the function P_{MUSIC}(φ).

ESPRIT is another parameter estimation technique, based on the fact that in the steering vector, the signal at one element is a constant phase shift from the earlier element. As in equations above, let,

zₘ=e^{jkd cos φ}^{ₘ}

Using equations above, the correlation matrix is dependent on S, the N×M matrix of steering vectors given by,

$$S = [ \begin{matrix}1 & 1 & ⋯ & 1 \\ {z}_{1} & {z}_{2} & ⋯ & {z}_{M} \\ ⋮ & ⋮ & ⋱ & ⋮ \\ {z}_{1}^{N - 2} & {z}_{2}^{N - 2} & ⋯ & {z}_{M}^{N - 2} \\ {z}_{1}^{N - 1} & {z}_{2}^{N - 1} & ⋯ & {z}_{M}^{N - 1}\end{matrix} ]$$

Based on the matrix, define two (N−1)×M matrices, S₀ and S₁,

$${S}_{0} = [ \begin{matrix}1 & 1 & ⋯ & 1 \\ {z}_{1} & {z}_{2} & ⋯ & {z}_{M} \\ ⋮ & ⋮ & ⋱ & ⋮ \\ ⋮ & ⋮ & ⋯ & {z}_{M}^{N - 2} \\ {z}_{1}^{N - 1} & {z}_{2}^{N - 1} & ⋯ & {z}_{M}^{N - 1}\end{matrix} ]$$

$${S}_{1} = [ \begin{matrix}1 & 1 & ⋯ & 1 \\ {z}_{1} & {z}_{2} & ⋯ & {z}_{M} \\ ⋮ & ⋮ & ⋱ & ⋮ \\ {z}_{1}^{N - 2} & {z}_{2}^{N - 2} & ⋯ & {z}_{M}^{N - 2} \\ {z}_{1}^{N - 1} & {z}_{2}^{N - 1} & ⋯ & {z}_{M}^{N - 1}\end{matrix} ]$$

and note that S₁=S₀ψ, where ψ is the M×M matrix,

$$ψ = [ \begin{matrix}{z}_{1} & 0 & ⋯ & 0 \\ 0 & {z}_{2} & ⋯ & 0 \\ ⋮ & ⋮ & ⋱ & ⋮ \\ 0 & 0 & ⋯ & {z}_{M}\end{matrix} ]$$

That is, ψ is a diagonal matrix whose entries correspond to the phase shift from one element to the next due to each individual signal. Estimating 4, allows for estimating the DOA of all signals using equations above.

If S₀ and S₁ were known, ψ can be solved for. Because these are unknown matrices, proxies must be used to obtain the same result. The ESPRIT algorithm begins by recognizing that the steering vectors in matrix S span the same subspace as the matrix Qₛ, the N×M matrix of signal eigenvectors. Since both these matrices span the same subspace, there exists an invertible matrix C such that

Qₛ=SC

Defining matrices Q₀ and Q₁ derived from Q just as S₀ and S₁ were derived from S, i.e., Q₀ comprises the first (N−1) rows of Q and Q₁ the last (N−1) rows of Q, and using equations above, results in,

Q₀=S₀C

Q₁=S₁C=S₀ψC

Consider,

Q₁C₋₁ψ₋₁C=S₀ψCC₋₁ψ₋₁C=S₀C=Q₀

Now, let,

$${ψ}_{- 1} = {C}_{- 1} {ψ}_{- 1} C ⇒ {Q}_{1} {ψ}_{- 1} = {Q}_{0} ⇒ {Q}_{i} = {Q}_{0} ϕ$$

where

φ=C₋₁ψC

The equation implies that the matrix ψ is a diagonal matrix of the eigenvalues of φ. Using the equations above, there is a complete algorithm. The steps of ESPRIT are to estimate the correlation matrix R using equations above and find the eigendecomposition R=QΛQ_{H}. Partition Q to obtain Qₛ, corresponding to the M largest eigenvalues of Q, which spans the signal subspace. Using least squares the equations can be solved to obtain an estimate of the M×M matrix φ. Find the eigenvalues of φ. Its diagonal elements are the estimates of zₘ being sought. Obtain the DOA using equations above.

In practice, one would obtain the estimate of φ not using least squares, but Total Least Squares (TLS). This is an improved least squares technique. Note that ESPRIT represents a significantly greater computation load than MUSIC. This is because two eigendecompositions are needed, of the correlation matrix R and the estimated φ. Furthermore, a least squares problem is solved to estimate φ.

So far, the “adaptive” algorithms developed, the MLE, MUSIC, and ESPRIT, are all dependent on an estimate of the correlation matrix R. Estimating this matrix is a significant computational load as at least K samples of the data x (K snapshots) are needed where K>2N. The inherent assumption is that all K samples follow the same statistics, i.e., the data is homogeneous. In an environment in which the fading characteristics are rapidly changing, this may not be valid. More importantly, estimating the correlation matrix is computationally intensive.

This motivates the development of a “non-statistical” or “direct data domain” (D3) technique known as Matrix Pencil. Matrix Pencil may estimate the poles of a system. However, it can be applied as well to DOA estimation. In the original Matrix Pencil, the received data at time index n is given by,

$${x}_{n} = {\sum }_{m = 1}^{M} {A}_{m} {z}_{m}^{n} + {n}_{n}$$

where

zₘ=e^{jkd cos φ}^{ₘ}^{Δt}

represents the poles of the system, nₙ represents the AWGN. The goal is to estimate zₘ given xₙ, n=0, . . . N−1.

Here, the data is received at the terminals of the N antenna elements, otherwise the formulation is exactly the same. Hence, the original Matrix Pencil algorithm is applicable to DOA estimation. The Matrix Pencil has many similarities to the ESPRIT technique, however without estimating a correlation matrix. Begin by defining two (N−L)×L matrices X₀ and X₁ as,

$${X}_{0} = [ \begin{matrix}{x}_{0} & {x}_{1} & ⋯ & {x}_{L - 1} \\ {x}_{1} & {x}_{2} & ⋯ & {x}_{L} \\ ⋮ & ⋮ & ⋱ & ⋮ \\ {x}_{N - L - 1} & {x}_{N - L} & ⋯ & {x}_{N - 1}\end{matrix} ]$$

$${X}_{1} = [ \begin{matrix}{x}_{1} & {x}_{2} & ⋯ & {x}_{L} \\ {x}_{2} & {x}_{3} & ⋯ & {x}_{L + 1} \\ ⋮ & ⋮ & ⋱ & ⋮ \\ {x}_{N - L} & {x}_{N - L + 1} & ⋯ & {x}_{N - 1}\end{matrix} ]$$

where L is a pencil parameter that must satisfy

M≤L≤N−L

for N even, and

M≤L≤N−L+1

for N odd.

The basis of Matrix Pencil is that, based on the data model, the matrices can be expressed as

X₀=Z₁AZ₂

X₁=Z₁AψZ₂

where ψ is the same as in ESPRIT, the diagonal matrix that is estimated. The four matrices are given by,

$${Z}_{1} = {[ \begin{matrix}1 & 1 & ⋯ & 1 \\ {z}_{1} & {z}_{2} & ⋯ & {z}_{M} \\ ⋮ & ⋮ & ⋱ & ⋮ \\ {z}_{1}^{N - L - 1} & {z}_{2}^{N - L - 1} & ⋯ & {z}_{M}^{N - L - 1}\end{matrix} ]}_{( N - L ) \times M}$$

$${Z}_{2} = {[ \begin{matrix}1 & {z}_{1} & ⋯ & {z}_{1}^{L - 1} \\ 1 & {z}_{2} & ⋯ & {z}_{2}^{L - 1} \\ ⋮ & ⋮ & ⋱ & ⋮ \\ 1 & {z}_{M} & ⋯ & {z}_{M}^{L - 1}\end{matrix} ]}_{M \times L}$$

$$ψ = {[ \begin{matrix}{z}_{1} & 0 & ⋯ & 0 \\ 0 & {z}_{2} & ⋯ & 0 \\ ⋮ & ⋮ & ⋱ & ⋮ \\ 0 & 0 & ⋯ & {z}_{M}\end{matrix} ]}_{M \times M}$$

$$A = {[ \begin{matrix}{β}_{1} & 0 & ⋯ & 0 \\ 0 & {β}_{2} & ⋯ & 0 \\ ⋮ & ⋮ & ⋱ & ⋮ \\ 0 & 0 & ⋯ & {β}_{M}\end{matrix} ]}_{M \times M}$$

Without noise, for the choice of pencil parameter L that satisfies the constraint the matrices X₀ and X₁ have rank M. Consider the matrix pencil X₁−λX₀=Z₁A(ψ−λI)Z₂. For arbitrary λ, this matrix difference also has rank M. However, if λ is one of the zₘ, i.e., λ=zₘ, for some m∈[1, M], the rank of the matrix difference reduces by one to M−1. This implies that the poles (zₘ) can be found as the generalized eigenvalues of the matrix pair [X₀, X₁], i.e.,

X₁q=λX₀q

Note that q, the generalized eigenvector, has no relationship to the eigenvectors of the correlation matrix. The M generalized eigenvalues of this matrix pair form the estimates of the zₘ and the DOA may be obtained using equations above. The steps of Matrix Pencil are therefore given N and M, choose L to satisfy the equation, form matrices X₀ and X₁, find zₘ as the generalized eigenvalues of the matrix pair [X₀, X₁], and find the DOA using equations above. Note that finding the generalized eigenvalues of the matrix pair [X₀, X₁] is equivalent to finding the eigenvalues of

$${( {X}_{0}^{H} {X}_{0} )}^{- 1} {X}_{0}^{H} {X}_{1}$$

The similarities of Matrix Pencil and ESPRIT are clear. Both algorithms estimate a diagonal matrix whose entries are the poles of the system (zₘ). A major difference is that ESPRIT works with the signal subspace as defined by the correlation matrix, while Matrix Pencil works with the data directly. This represents a significant savings in terms of computation load.

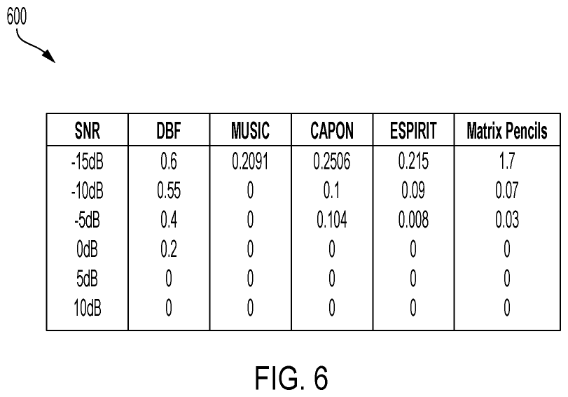

The table 600 in FIG. 6 lists the performance of different algorithms for various SNR targets. It shows the Mean Squared Error (MSE) between the ground truth and the measured angle for each algorithm. This table 600 represents that all the algorithms are working as expected for the simulated single target 11.

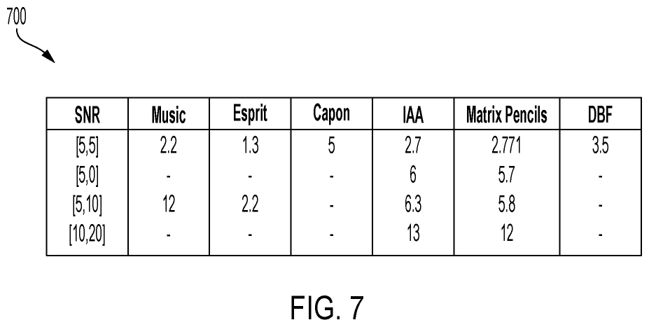

The table 700 of FIG. 7 shows the performance of multiple targets 11 separated by 20 degrees between them. The table 600 of FIG. 6 represents the MSE error from the ground truth of the target 11 for different SNRs.

The table 700 of FIG. 7 indicates that it is challenging to detect two targets 11 with a 20-degree separation using the current antenna configuration. However, algorithms such as MUSIC, Capon, ESPRIT, and IAA perform well in detecting two targets 11 with a 20-degree separation.

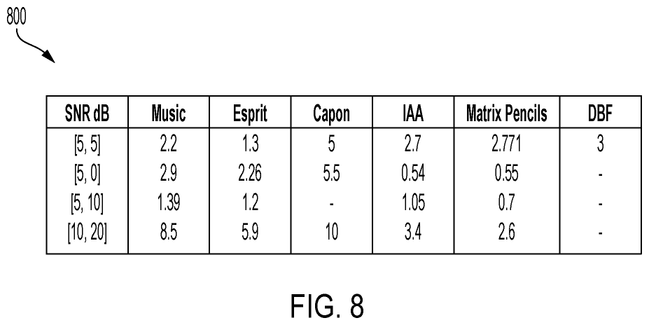

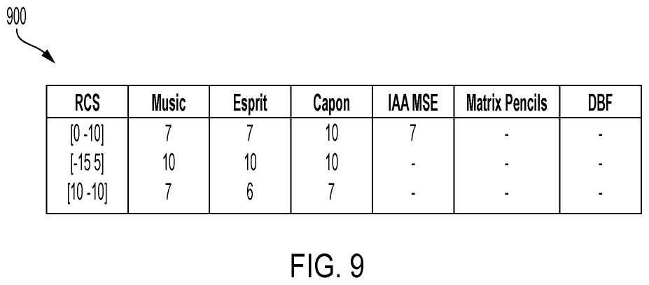

The table 800 of FIG. 8 shows the MSE performance when the targets 11 are kept 40 degrees apart. LAB Data with multiple targets 11 and targets are 20 degrees apart from each other in azimuth directions. The table 900 of FIG. 9 represents the MSE performance of different algorithms when the targets 11 are kept 20 degrees apart.

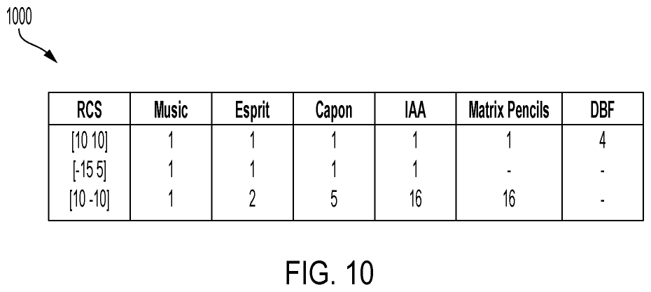

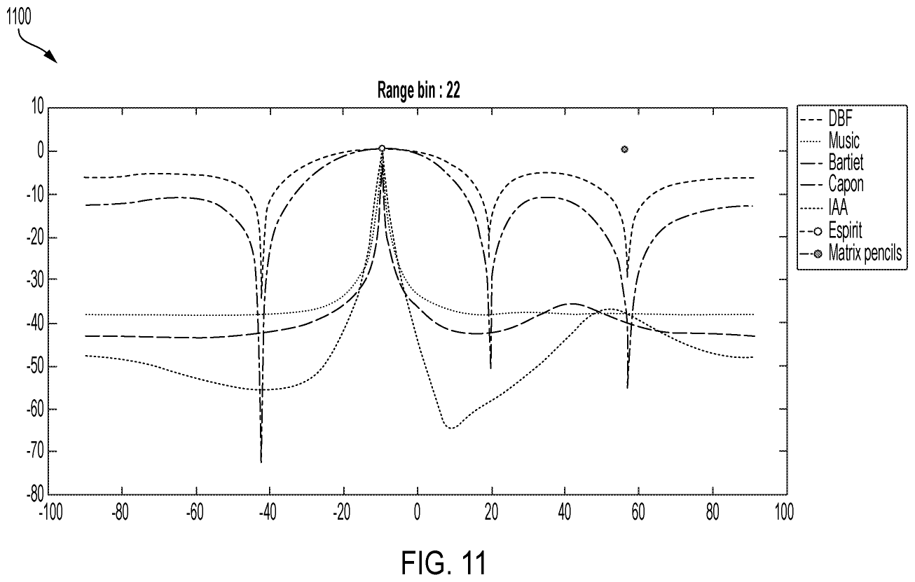

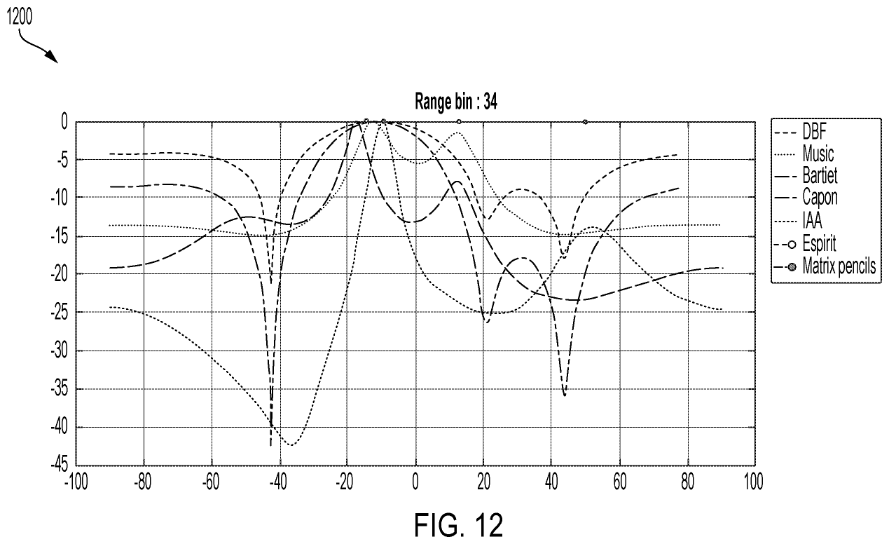

The table 1000 of FIG. 10 represents the Mean Squared Error (MSE) data for multiple targets 11 that are 40 degrees apart from each other, based on laboratory measurements. The table 900 of FIG. 9 represents the MSE performance of different algorithms when the targets 11 are kept 20 degrees apart. It is observed that the best estimates of targets 11 from real data are obtained when the targets 11 have a Radar Cross Section (RCS) difference of more than 10 dBsm (decibels relative to a square meter) and are 40 degrees apart in the angle domain. While the ESPRIT algorithm provides superior performance, considering computational cost, the Capon and MUSIC algorithms also offer excellent target resolution compared to DBF and other algorithms. Single target simulated data 1100 is shown in FIG. 11. Multiple targets simulated data 1200 is shown in FIG. 12.

As seen in FIG. 12, there is significant interaction between the two targets 11 when they are close, making it difficult for traditional signal processing algorithms like DBF to resolve the targets. In such cases, high-resolution algorithms are able to accurately detect and resolve the targets 11.

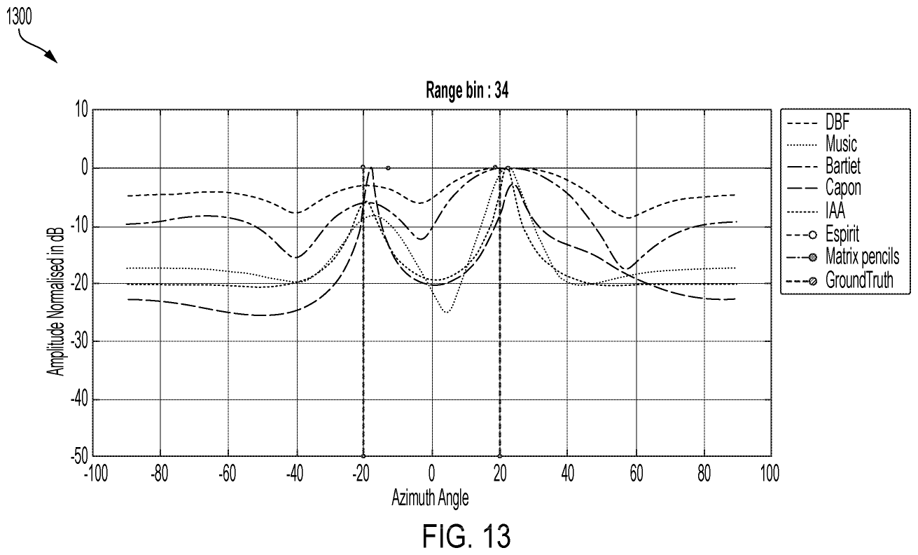

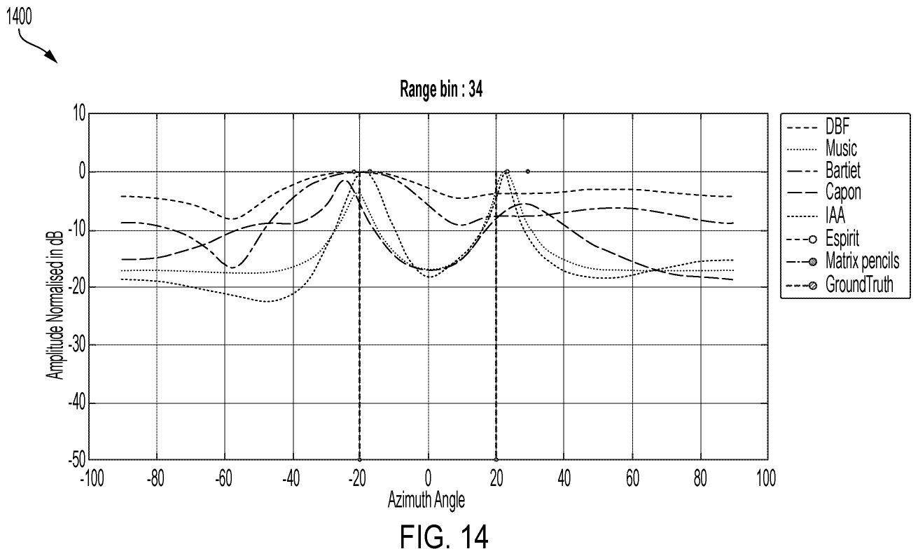

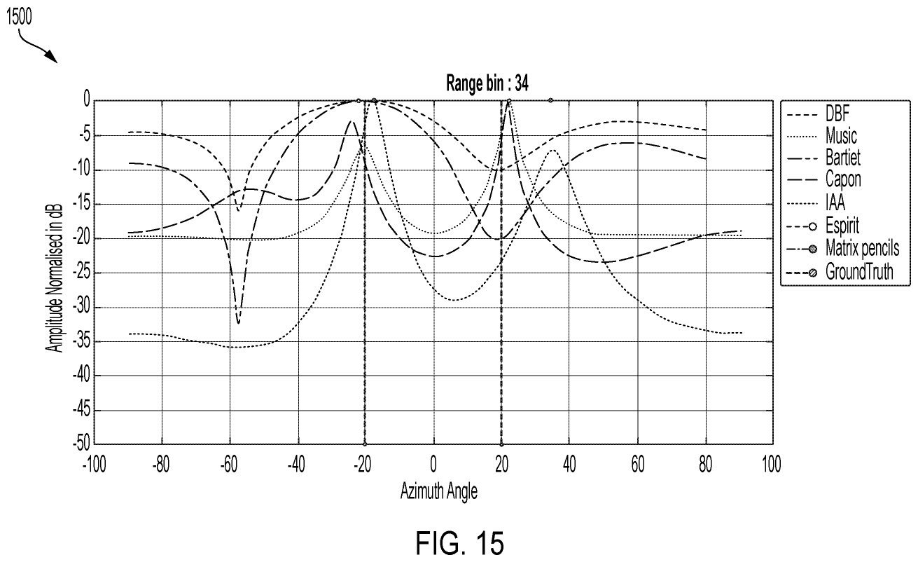

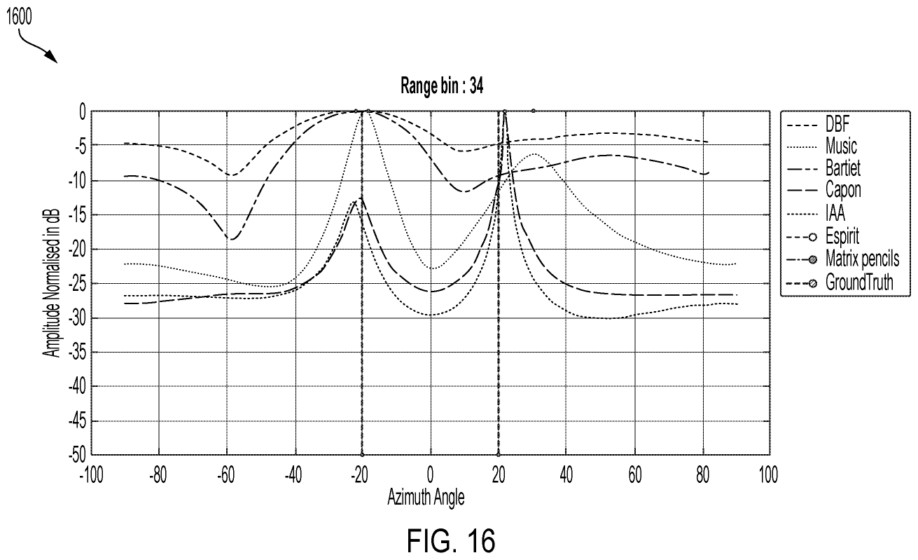

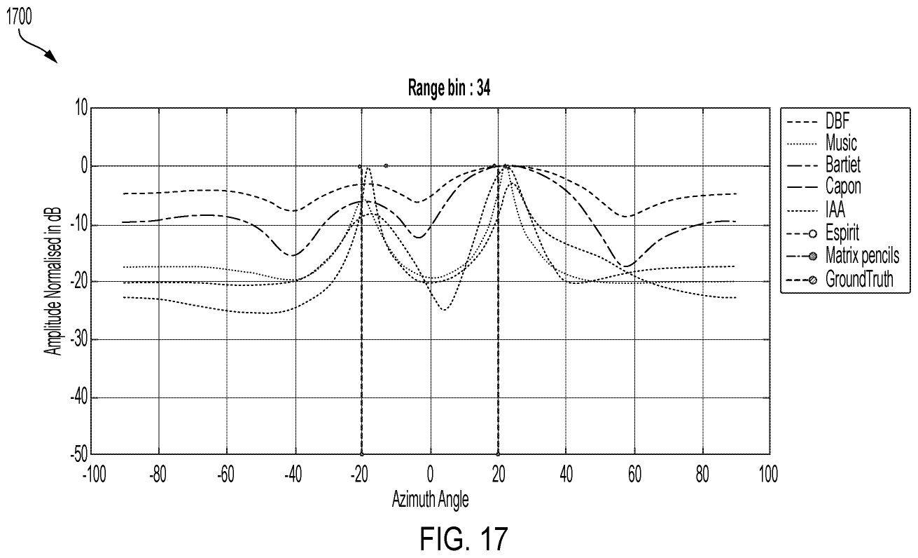

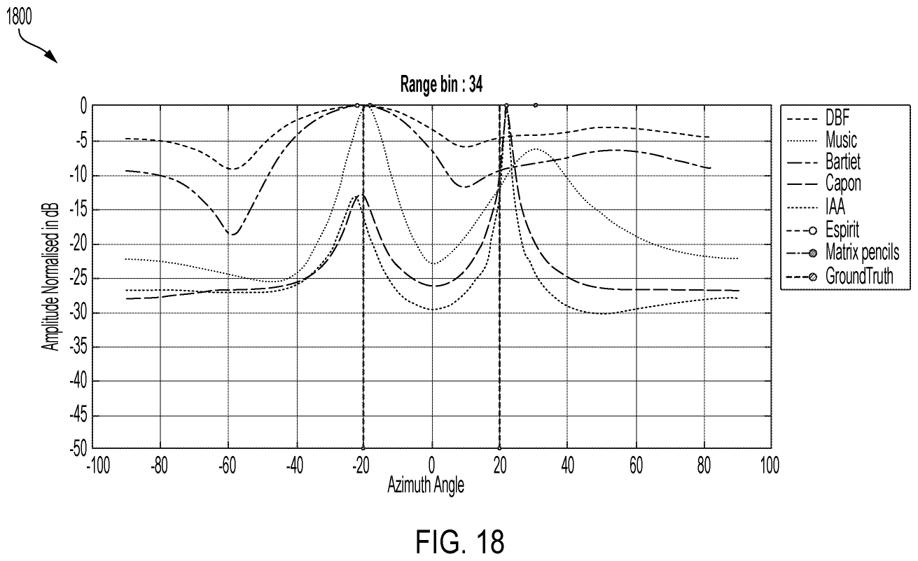

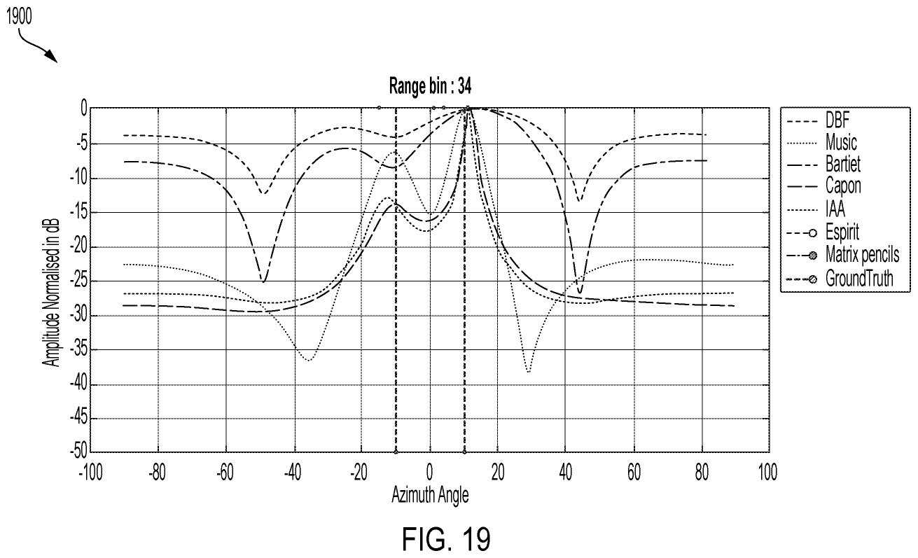

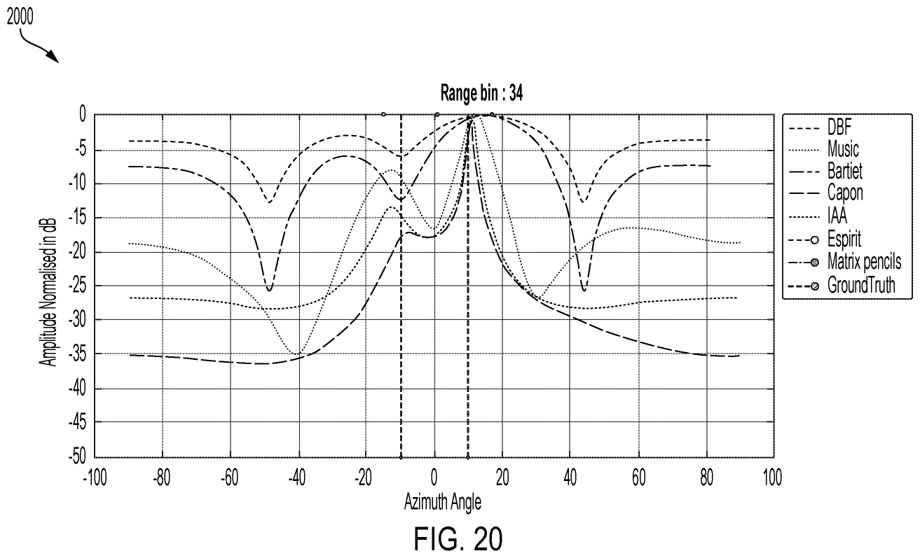

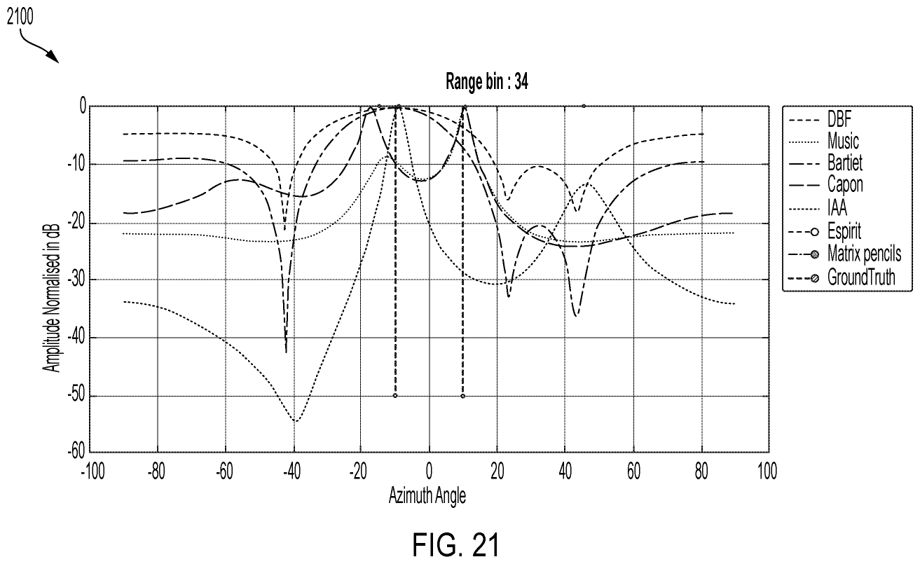

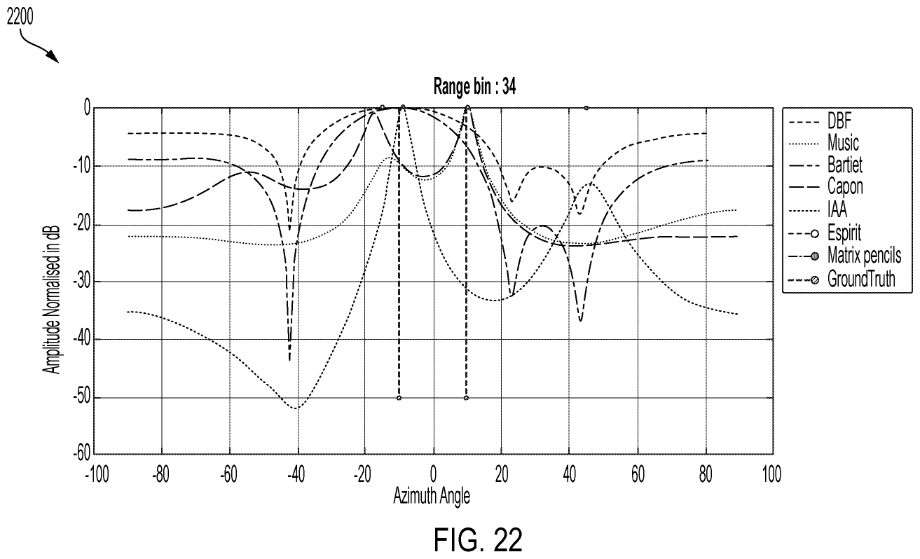

The chart 1300 of FIG. 13 demonstrates that when the targets 11 are 40 degrees apart, most of the algorithms are able to successfully detect and resolve the targets. Referring to FIGS. 13-22, it is observed that most high-resolution algorithms successfully detect targets 11 that are 40 degrees apart, even when there is a significant difference in RCS of up to 20 dBsm. From the charts 1300, 1400, 1500, 1600, 1700, 1800, 1900, 2000, 2100, 2200 of FIGS. 13-22, it is evident that the MUSIC, ESPRIT, and Capon algorithms excel in resolving two targets even in high noise environments.

It is evident that the MUSIC algorithm performs well in high noise and weak target environments, provided the number of targets 11 is known beforehand. The accuracy of target position estimates is closely tied to the precision with which we can provide the number of targets 11 to the system. Given that the vehicle in-cabin environment is relatively stable, with occupants typically remaining in one position for extended periods, the signal characteristics are likely to remain consistent until there is a change in the environment (such as a person changing their position). A Convolutional Neural Network (CNN) and the range-channel map may be used to determine the number of possible targets. Architecture of the CNN 20 is shown in FIG. 2.

The system involves storing information about a target 11 and, upon the appearance of a new target 11, beam steering to each seat location to verify the presence of the target 11.

Data is simulated with different target RCS reflecting as a different SNRs and checked with different algorithms for detectability of the target 11. From the simulated data the system can detect multiple targets 11 with high resolution signal processing as shown in FIGS. 13-22. It is seen from simulated data IAA is performing better with a slightly lower computation cost when the signal presence is stronger. It is seen from FIG. 2 that when the targets 11 are closely spaced and the second target 11 is very weak, CAPON, MUSIC and ESPIRIT is outperforming other algorithms in detecting the targets 11. The main problem with these algorithms is to know about number of targets as a prior knowledge. Since the environment is not highly dynamic, the number of targets 11 can be estimated from the CNN module 20 and that can be fed as information to MUSIC kind of high resolution algorithms.

For example, the system may receive an input indicative of the number of passengers at the passenger region or the system may estimate or determine the number of passengers (such as via the CNN module or via processing radar data captured by the radar sensor), and then attempts to find that number of passengers via processing radar data captured by the radar sensor. The system may determine that a low signal potential target is an unaccounted for passenger even though the signal is weak. For example, if the system knows there are three passengers, and finds two with strong signal targets, the system would look at other locations for a weak signal target and determine that the weak signal target is the third passenger.

In other words, the vehicular cabin monitoring system 12 includes one or more radar sensors 16 disposed within the interior cabin of the vehicle 10. For example, the radar sensor 16 is disposed at an overhead console module of the vehicle for sensing the driver region of the interior cabin, a front passenger region of the interior cabin, and/or one or more rear passenger regions of the interior cabin of the vehicle. Optionally, the radar sensor 16 is configured to sense within a cargo region of the vehicle. The cabin monitoring system 12 processes sensor data captured by the one or more radar sensors 16 to determine presence of occupants within the vehicle cabin 14 and/or determine positions of the occupants within the cabin. For example, the system 12 may continuously monitor the cabin during operation of the vehicle or in response to a vehicle condition, such as within a threshold period of time after the vehicle is parked and turned off, or in response to detecting that the vehicle has been involved in a collision.

Because radar sensor data may include occlusions or faint signals that make it difficult to detect occupants within the cabin of the vehicle, the system may first determine or estimate a number of occupants within the cabin. For example, the system may receive an estimated number of occupants from a seatbelt monitoring system, from a camera-based driver monitoring system (DMS) and/or occupant monitoring system (OMS), and the like. In some examples, the system estimates a number of occupants based on sensor data captured by the radar system. The system may train the CNN 20 and/or determine the number of occupants based on processing by the CNN 20. For example, the system may compare radar sensor data, DMS or OMS image data, and/or indications from the seatbelt monitoring system to improve occupant detection.

Based on the estimated number of occupants, the system may determine positions of the occupants based on signal strength from the radar system. For example, based on the signal strength at two positions being different by at least 10 dBsm RCS, the system may determine the first position as one occupant and determine the second position as another occupant. The two occupants may include one adult and one child. The two positions may be, for example 20 degrees azimuth apart or 40 degrees or more azimuth apart within the interior cabin of the vehicle relative to the radar sensor.

The system may determine the positions of the vehicle occupants via MUSIC techniques, ESPRIT algorithms, CAPON techniques, and the like. Moreover, the radar sensor may comprise a MIMO radar system, a FMCW radar system, and the like.

Based on determining the positions of the occupants, the system may determine presence of an unattended child within the vehicle and generate an alert exterior the vehicle. For example, the system may flash the lights of the vehicle, honk a horn of the vehicle, play an audio message exterior the vehicle, wirelessly transmit a message to a mobile device associated with an owner or driver of the vehicle (e.g., via a text message, push notification, email, and the like), wirelessly transmit a message to a third party (e.g., emergency services) and the like. Improved detection of occupants within the vehicle leads to more accurate and faster alerts, leading to greater safety for unattended child occupants.

The vehicular cabin monitoring system may utilize characteristics of the heart rate measurement systems and driver monitoring systems described in U.S. Pat. Nos. 12,539,857 and/or 11,433,906, which are hereby incorporated herein by reference in their entireties.

The system thus may utilize sensors, such as radar sensors or imaging radar sensors, to detect presence of and/or range to objects. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving monitoring system of the vehicle or occupant monitoring system of the vehicle or cabin monitoring system of the vehicle or driving assist system of the vehicle, with the driving assist system controlling at least one function or feature of the vehicle (such as to provide autonomous driving control of the vehicle) responsive to processing of the data captured by the radar sensors.

The radar sensor or sensors may be disposed at the vehicle so as to sense exterior of the vehicle. For example, the radar sensor may comprise a front or forward-sensing radar sensor mounted at a grille or front bumper of the vehicle, such as for use with an automatic emergency braking system of the vehicle, an adaptive cruise control system of the vehicle, a collision avoidance system of the vehicle, etc., or the radar sensor may be comprise a corner radar sensor disposed at a front corner or rear corner of the vehicle, such as for use with a surround vision system of the vehicle, or the radar sensor may comprise a blind spot monitoring radars disposed at a rear fender of the vehicle for monitoring sideward/rearward of the vehicle for a blind spot monitoring and alert system of the vehicle. Optionally, the radar sensor or sensors may be disposed within the vehicle so as to sense interior of the vehicle, such as for use with a cabin monitoring system of the vehicle or a driver monitoring system of the vehicle or an occupant detection or monitoring system of the vehicle. The radar sensing system may comprise multiple input multiple output (MIMO) radar sensors having multiple transmitting antennas and multiple receiving antennas.

The ECU may be operable to process data for at least one driving assist system of the vehicle. For example, the ECU may be operable to process data (such as image data captured by a forward-viewing camera of the vehicle that views forward of the vehicle through the windshield of the vehicle) for at least one selected from the group consisting of (i) a headlamp control system of the vehicle, (ii) a pedestrian detection system of the vehicle, (iii) a traffic sign recognition system of the vehicle, (iv) a collision avoidance system of the vehicle, (v) an emergency braking system of the vehicle, (vi) a lane departure warning system of the vehicle, (vii) a lane keep assist system of the vehicle, (viii) a blind spot monitoring system of the vehicle and (ix) an adaptive cruise control system of the vehicle. Optionally, the ECU may also or otherwise process radar data captured by a radar sensor of the vehicle or other data captured by other sensors of the vehicle (such as other cameras or radar sensors or such as one or more lidar sensors of the vehicle). Optionally, the ECU may process captured data for an autonomous control system of the vehicle that controls steering and/or braking and/or accelerating of the vehicle as the vehicle travels along the road.

The system may utilize aspects of driver monitoring systems and/or head and face direction and position tracking systems and/or eye tracking systems and/or gesture recognition systems. Such head and face direction and/or position tracking systems and/or eye tracking systems and/or gesture recognition systems may utilize aspects of the systems described in U.S. Pat. Nos. 12,403,834; 12,393,089; 11,827,153; 11,780,372; 11,639,134; 11,582,425; 11,518,401; 10,958,830; 10,065,574; 10,017,114; 9,405,120 and/or 7,914,187, and/or U.S. Publication Nos. US-2025-0329174; US-2024-0383406; US-2024-0190456; US-2024-0168355; US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or International Publication Nos. WO 2026/019985 and/or WO 2025/231198, which are all hereby incorporated herein by reference in their entireties.

The interior-viewing camera may be disposed at the mirror head of the interior rearview mirror assembly and moves together and in tandem with the mirror head when the driver of the vehicle adjusts the mirror head to adjust his or her rearward view. The interior-viewing camera may be disposed at a lower or chin region of the mirror head below the mirror reflective element of the mirror head, or the interior-viewing camera may be disposed behind the mirror reflective element and viewing through the mirror reflective element. Similarly, the light emitter may be disposed at the lower or chin region of the mirror head below the mirror reflective element of the mirror head (such as to one side or the other of the interior-viewing camera), or the light emitter may be disposed behind the mirror reflective element and emitting light that passes through the mirror reflective element. The ECU may be disposed at the mirror assembly (such as accommodated by the mirror head), or the ECU may be disposed elsewhere in the vehicle remote from the mirror assembly, whereby image data captured by the interior-viewing camera may be transferred to the ECU via a coaxial cable or other suitable communication line. Cabin monitoring or occupant detection may be achieved via processing at the ECU of image data captured by the interior-viewing camera. Optionally, cabin monitoring or occupant detection may be achieved in part via processing at the ECU of radar data captured by one or more interior-sensing radar sensors disposed within the vehicle and sensing the interior cabin of the vehicle.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular cabin monitoring system, the vehicular cabin monitoring system comprising:
a radar sensor disposed within an interior cabin of a vehicle equipped with the vehicular cabin monitoring system, wherein the radar sensor senses within the interior cabin of the vehicle;
an electronic control unit (ECU);
wherein sensor data captured by the radar sensor is transferred to the ECU;
wherein the ECU comprises electronic circuitry and associated software, and wherein the electronic circuitry of the ECU comprises a processor operable to process sensor data transferred to the ECU;
wherein the vehicular cabin monitoring system, via processing at the ECU of sensor data captured by the radar sensor, monitors a passenger region within the interior cabin of the vehicle; and
wherein the vehicular cabin monitoring system, based at least in part on a number of occupants present at the passenger region within the interior cabin of the vehicle, and responsive to sensor data representative of a first passenger region of the passenger region within the interior cabin of the vehicle and sensor data representative of a second passenger region of the passenger region within the interior cabin of the vehicle being different by at least 10 dBsm RCS, (i) determines a first position of a first occupant present at the first passenger region within the interior cabin of the vehicle and (ii) determines a second position of a second occupant present at the second passenger region within the interior cabin of the vehicle.

2. The vehicular cabin monitoring system of claim 1, wherein the vehicular cabin monitoring system estimates the number of occupants present at the passenger region within the interior cabin of the vehicle based at least in part on processing at the ECU of sensor data captured by the radar sensor.

3. The vehicular cabin monitoring system of claim 1, wherein the vehicular cabin monitoring system estimates the number of occupants present at the passenger region within the interior cabin of the vehicle based at least in part on processing by a convolutional neural network.

4. The vehicular cabin monitoring system of claim 1, wherein the vehicular cabin monitoring system receives a signal from a system of the vehicle that indicates the number of occupants present at the passenger region within the interior cabin of the vehicle.

5. The vehicular cabin monitoring system of claim 4, wherein the system comprises a seatbelt monitoring system of the vehicle.

6. The vehicular cabin monitoring system of claim 1, wherein the first position and the second position are greater than or equal to 20 degrees azimuth apart within the interior cabin of the vehicle relative to the radar sensor.

7. The vehicular cabin monitoring system of claim 1, wherein the first position and the second position are greater than or equal to 40 degrees azimuth apart within the interior cabin of the vehicle relative to the radar sensor.

8. The vehicular cabin monitoring system of claim 1, wherein the vehicular cabin monitoring system determines the first position of the first occupant and determines the second position of the second occupant via Multiple Signal Classification (MUSIC) techniques.

9. The vehicular cabin monitoring system of claim 1, wherein the vehicular cabin monitoring system determines the first position of the first occupant and determines the second position of the second occupant via Estimation of Signal Parameters via Rotational Invariance Techniques (ESPRIT).

10. The vehicular cabin monitoring system of claim 1, wherein the vehicular cabin monitoring system determines the first position of the first occupant and determines the second position of the second occupant via CAPON techniques.

11. The vehicular cabin monitoring system of claim 1, wherein the radar sensor comprises a Multiple-Input Multiple-Output (MIMO) radar system.

12. The vehicular cabin monitoring system of claim 1, wherein the radar sensor comprises a Frequently Modulated Continuous Wave (FMCW) radar system.

13. The vehicular cabin monitoring system of claim 1, wherein responsive to determining the first position of the first occupant and determining the second position of the second occupant, the vehicular cabin monitoring system generates an alert exterior of the vehicle indicative of presence of the first occupant and the second occupant.

14. A vehicular cabin monitoring system, the vehicular cabin monitoring system comprising:
a radar sensor disposed within an interior cabin of a vehicle equipped with the vehicular cabin monitoring system, wherein the radar sensor senses within the interior cabin of the vehicle;
an electronic control unit (ECU);
wherein sensor data captured by the radar sensor is transferred to the ECU;
wherein the ECU comprises electronic circuitry and associated software, and wherein the electronic circuitry of the ECU comprises a processor operable to process sensor data transferred to the ECU;
wherein the vehicular cabin monitoring system, via processing at the ECU of sensor data captured by the radar sensor, monitors a passenger region within the interior cabin of the vehicle;
wherein the vehicular cabin monitoring system receives a signal from a system of the vehicle that indicates a number of occupants present at the passenger region within the interior cabin of the vehicle;
wherein the vehicular cabin monitoring system, based at least in part on the number of occupants present at the passenger region within the interior cabin of the vehicle, and responsive to sensor data representative of a first passenger region of the passenger region within the interior cabin of the vehicle and sensor data representative of a second passenger region of the passenger region within the interior cabin of the vehicle being different by at least 10 dBsm RCS, (i) determines a first position of a first occupant present at the first passenger region within the interior cabin of the vehicle and (ii) determines a second position of a second occupant present at the second passenger region within the interior cabin of the vehicle; and
wherein responsive to determining the first position of the first occupant and determining the second position of the second occupant, the vehicular cabin monitoring system generates an alert exterior of the vehicle indicative of presence of the first occupant and the second occupant.

15. The vehicular cabin monitoring system of claim 14, wherein the system comprises a seatbelt monitoring system of the vehicle.

16. The vehicular cabin monitoring system of claim 14, wherein the first position and the second position are greater than or equal to 20 degrees azimuth apart within the interior cabin of the vehicle relative to the radar sensor.

17. The vehicular cabin monitoring system of claim 14, wherein the vehicular cabin monitoring system determines the first position of the first occupant and determines the second position of the second occupant via one selected from the group consisting of (i) Multiple Signal Classification (MUSIC) techniques, (ii) Estimation of Signal Parameters via Rotational Invariance Techniques (ESPRIT) and (iii) CAPON techniques.

18. The vehicular cabin monitoring system of claim 14, wherein the radar sensor comprises one selected from the group consisting of (i) a Multiple-Input Multiple-Output (MIMO) radar system and (ii) a Frequently Modulated Continuous Wave (FMCW) radar system.

19. A vehicular cabin monitoring system, the vehicular cabin monitoring system comprising:
a radar sensor disposed within an interior cabin of a vehicle equipped with the vehicular cabin monitoring system, wherein the radar sensor senses within the interior cabin of the vehicle;
an electronic control unit (ECU);
wherein sensor data captured by the radar sensor is transferred to the ECU;
wherein the ECU comprises electronic circuitry and associated software, and wherein the electronic circuitry of the ECU comprises a processor operable to process sensor data transferred to the ECU;
wherein the vehicular cabin monitoring system, via processing at the ECU of sensor data captured by the radar sensor, monitors a passenger region within the interior cabin of the vehicle;
wherein the vehicular cabin monitoring system estimates a number of occupants present at the passenger region within the interior cabin of the vehicle;
wherein the vehicular cabin monitoring system, based at least in part on the estimated number of occupants present at the passenger region within the interior cabin of the vehicle, and responsive to sensor data representative of a first passenger region of the passenger region within the interior cabin of the vehicle and sensor data representative of a second passenger region of the passenger region within the interior cabin of the vehicle being different by at least 10 dBsm RCS, (i) determines a first position of a first occupant present at the first passenger region within the interior cabin of the vehicle and (ii) determines a second position of a second occupant present at the second passenger region within the interior cabin of the vehicle;
wherein the first position and the second position are greater than or equal to 20 degrees azimuth apart within the interior cabin of the vehicle relative to the radar sensor; and
wherein responsive to determining the first position of the first occupant and determining the second position of the second occupant, the vehicular cabin monitoring system generates an alert exterior of the vehicle indicative of presence of the first occupant and the second occupant.

20. The vehicular cabin monitoring system of claim 19, wherein the vehicular cabin monitoring system estimates the number of occupants present at the passenger region within the interior cabin of the vehicle based at least in part on at least one selected from the group consisting of (i) processing at the ECU of sensor data captured by the radar sensor and (ii) processing by a convolutional neural network.
